(19) United States
(12) Patent Application Publication
(10) Pub. No.: US 2006/0212547 A1
(43) Pub. Date: Sep. 21, 2006

(54) Router or bridge device comprising an installation application

(76) Inventors: Johan Deleu, Schelle (BE); Gert Vranken, Alken (BE); Peter Cosemans, Lint (BE)

Correspondence Address: THOMSON LICENSING INC., PATENT OPERATIONS, PO BOX 5312, PRINCETON, NJ, 08543-5312, US

(21) Appl. No.: 10/534,629

(22) PCT Filed: Nov. 13, 2003
(86) PCT No.: PCT/EP03/12835

§ 371 Date: Dec. 12, 2005

(30) Foreign Application Priority Data
Nov. 13, 2002 (EP) 02447220.1

(51) Int. Cl. G06F 15/177

(52) U.S. Cl. 709/220; 370/254

(57) ABSTRACT

A router or bridge device for connecting for example a local area network to a wide area network is described. According to the invention, the router comprises: means for connection to a first network and means for connection to a second network; an application for selecting configuration parameters, wherein the application applies a template for presenting parameters to a user, said template being uploadable to said device.

A router or bridge device comprising an installation application Many networking devices, such as a router or a bridge, adapted to connect a personal computer or similar device or more largely a Local Area Network (LAN) to a Wide Area Network (WAN), are shipped with an installation application (usually called a ‘wizard’) running on a personal computer connected to the router through a local network or directly, and enabling the technically inexperienced end user to configure this product, initially programmed with factory defaults settings, to the needs of the specific Internet Service Provider (‘ISP’) the end user has selected. Known wizards had (and apparently still have), one common behavior: they use a fixed pattern of questions to guide the end-user through the installation process.

If a specific ISP uses a relatively uncommon network setup (e.g. any setup different from Point to Point Protocol with Network Address Translation (‘PPP with NAT’) a corresponding customized wizard has to be provided by the router manufacturer.

To avoid the pitfall of having to design customized wizards over and over again, a configurable wizard was developed.

Using template text files, the behavior of this type of wizard can be customized in a very easy way: adding a single file on an installation CD before shipping it to the end user defines the setup wizard as it will present itself to the end user trying to install his router. Multiple templates are allowed, so that multiple router configuration types can be shipped on the CD.

By deciding what templates to include on the CD, the ISP can customize the wizard without intervention of the router manufacturer. The wizards discussed so far were all applications running on a PC platform. Contrary to a host driven installation where an application running on the host (PC, MAC, UNIX, LINUX, . . . controls the installation process, an embedded wizard runs on the DSL router itself and using an embedded web server, it interacts with the end user through an interface that is available on most known platforms: a web browser.

Fixed embedded wizards have all the drawbacks cited above. An ISP wanting an embedded wizard with specific behavior needs a customized software build to be installed on the router. Whereas a customized host wizard is relatively easy to develop and test, changing the wizard behavior of an embedded system is much longer and more complex.

The invention concerns a router or bridge device characterized in that it comprises
means for connection to a first network and means for connection to a second network;
an application for selecting configuration parameters, wherein the application applies a template for presenting parameters to a user, said template being uploadable to said device.

Software embedded in a real-time networking device is generally considered to be a complex task. However, the proposed solution allows simple configuration of an embedded wizard. Moreover, the solution is independent of a particular operating system of a host through which the device configuration is carried out (e.g. using a browser application).

The invention will be better understood through the description of a non-restricting embodiment, explained with the help of:

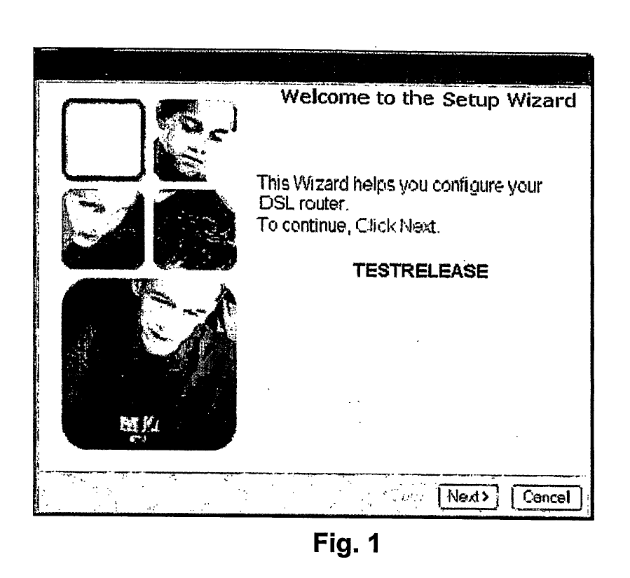

FIGS. 1 to 5, representing the user interface of an embedded installation application based on the template of appendix A, as shown using a personal computer browser application;

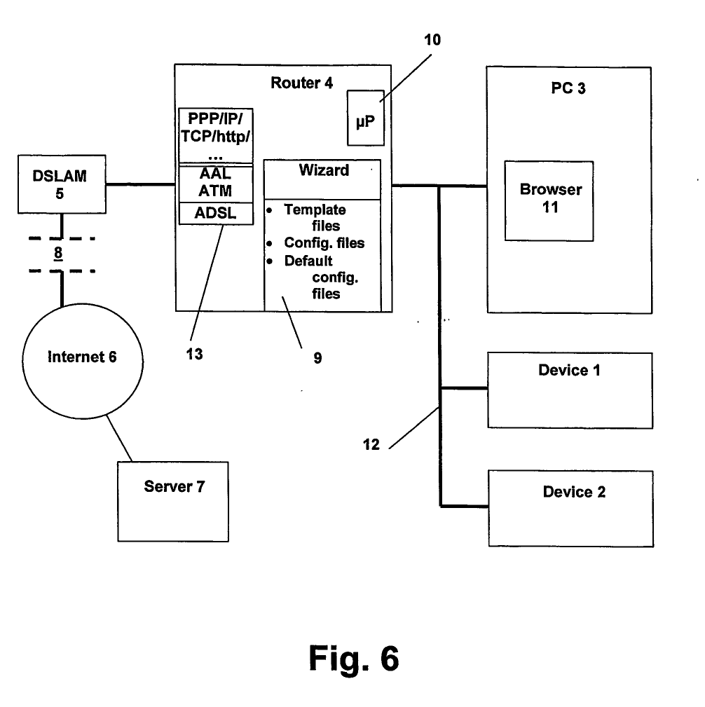

FIG. 6 representing a block diagram of a network comprising a device equipped with the installation application according to the embodiment;

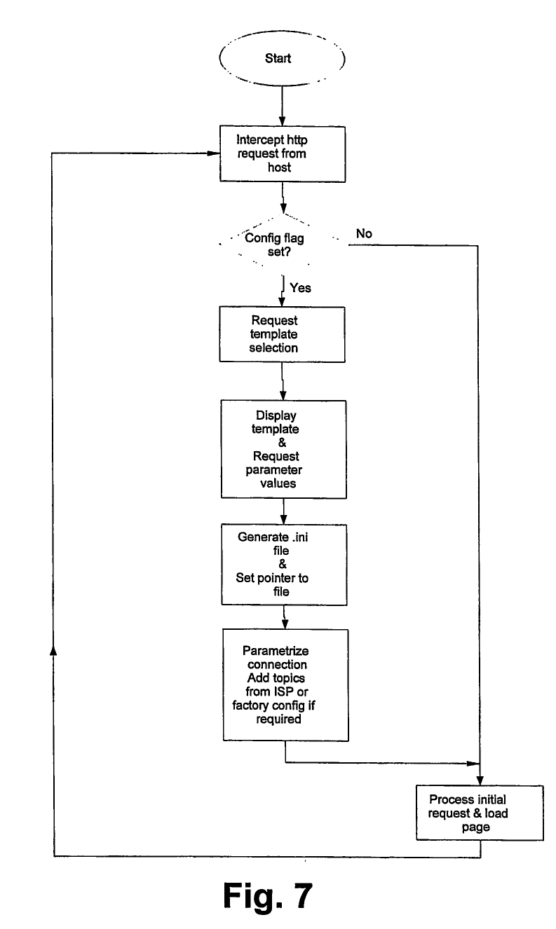

FIG. 7 is a flowchart of a process carried out by the software of the device.

The present embodiment concerns a DSL router, but is not limited to such an environment.

The inventors designed a configurable embedded wizard.

Using template text files the behavior of the wizard can be customized in a very easy way: a single file upload to the router before shipping it to the end user completely defines the setup wizard as it will present itself to the end user trying to install his router.

According to the present embodiment, multiple templates are allowed so that multiple DSL configuration types can be used on just one router. Multiple template files are stored concurrently in the router.

Although uploading the template file to the router should typically be done before shipping the router, it can be done in a very easy way by the end user as well. Templates activating new functionalities can be distributed via the ISP's portal, via email or any other electronic distribution system.

FIG. 6 is a block diagram of a network comprising a local area network connected to the Internet through a router 4. The local area network comprises, as an example, devices 1 and 2, as well as a personal computer 3, all connected through bus 12. Bus 12 is for example compliant with IEEE 802.3 (Ethernet). The personal computer runs a browser application 11, well known per se. The LAN also comprises a router 4, connected to a digital subscriber line access multiplexer (DSLAM) 5 through a local telephone line. The DSLAM is connected to the Internet in a known fashion through network 8. A server 7 may be accessed through this connection, in particular to download configuration templates.

The router 4 comprises a microprocessor 10 and a memory 9. The memory 9 stores an embedded installation application for setting up the router and configuring parameters described below. It also stores a boot program (not illustrated), as well as a template file, a user configuration file and a default configuration file.

The router also comprises the necessary physical interfaces to the LAN and the telephone line, as well as the corresponding protocols. These interfaces and protocols being well known per se, only the ADSL protocol stack 13 is illustrated as an example.

When the router is physically connected to the network and powered, it carries out a boot procedure. If no configuration has yet been carried out, a corresponding flag in the router indicates so. Further to booting, the router sets up a DHCP server and a DNS and HTTP intercept. The router is set as the default DNS server and gateway of the host personal computer (communicated using DHCP). When the personal computer issues a DNS or HTTP request (e.g. when the user wishes to set up a connection), this request is intercepted by the router and if the flag indicates that configuration still needs to be carried out, the request is redirected to the first page of the embedded wizard.

The wizard generates HTML pages based on the template file. These pages are accessed and displayed by the personal computer, the router acting as a server. In order to enable the personal computer to communicate with the router at this level, there must be IP connectivity between the two devices. In the present case, this implies that both the host and the router have IP addresses in the same IP network.

According to the present embodiment, the router upgrade and setup wizard can upload new templates to the router.

The following section explains in detail how the router's configurable embedded wizard according to the present embodiment works.

A default template is present on the router to cover often-used scenarios without the need for customization. The default template is for example the template used by a fixed embedded wizard of the prior art.

An ISP requiring a different wizard behavior will design a template file (or several such files) covering its needs and upload it to the router before shipping it to the end user.

Uploading a template can be done using the file transfer protocol (“ftp”) (typically in order fulfillment), through the router setup or upgrade wizard run on the computer 3, by the end user through one of the first choices presented to him through the embedded wizard, or using an ‘advanced file’ upload web page (i.e. a page allowing the uploading to the router of different files—.tpl, .ini, def). According to the present embodiment, the template file defines the wizard behavior:
How many screens, titles of the screens, subtitles and help text.
What questions are asked on every screen, including the corresponding help text . . .
The selection possibilities for every screen: text boxes, list boxes, combo boxes, radio buttons . . .

Using conditional command execution, a huge variety of configurations and configuration options can be stored in just one template file.

Based on the template file selected, the router according to the present embodiment generates the corresponding web pages comprising all necessary controls.

FIG. 1 represent a welcome page of the wizard. This page may comprise an appropriate explanation about the purpose and content of the setup and configuration process.

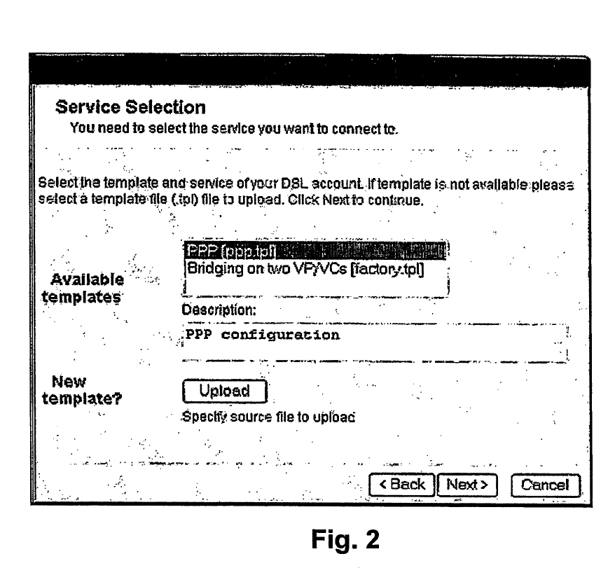

FIG. 2 represents a page that allows the user to select a template. This template may be a template already stored in the router. The user may also decide to upload a new template, to be added to the stored templates.

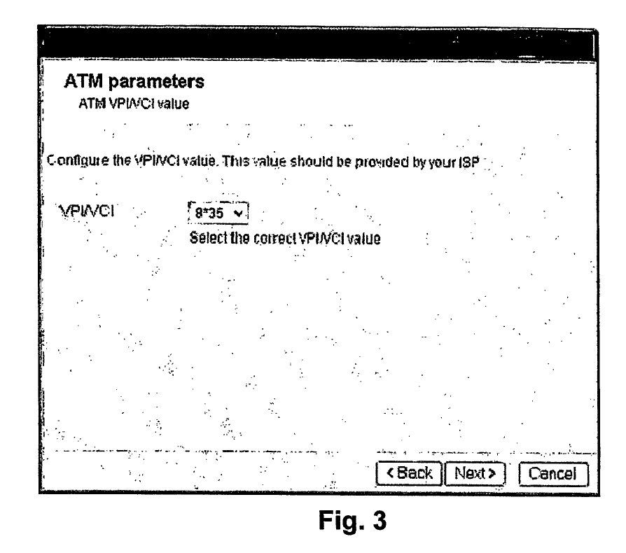

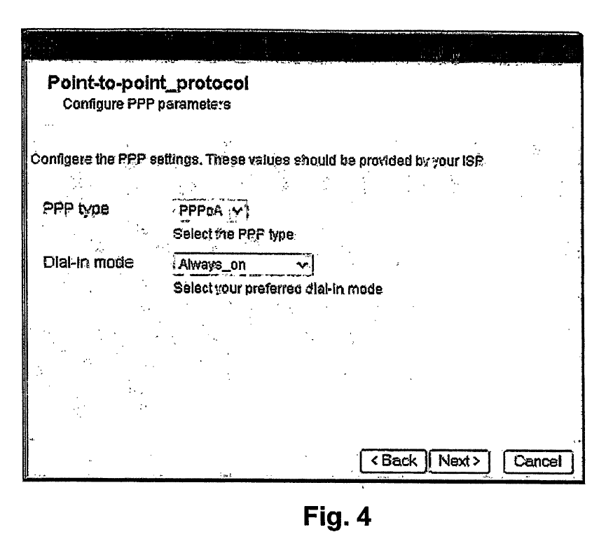

FIG. 3 represents a page giving the user the choice of configuring virtual path and virtual channel parameters, whereas FIG. 4 allows the user to configure PPP parameters. An extract of the template corresponding to the pages of FIGS. 3 and 4 is given in the Appendix A. FIGS. 3 and 4 represent just two parameter selection pages as a way of example, other pages may also be shown.

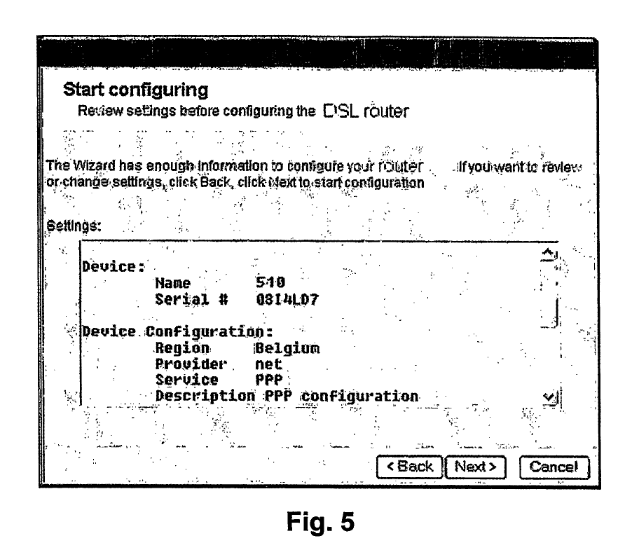

The page of FIG. 5 contains a list of parameter values previously selected, and allows the user to review the values. If these values are incorrect, the user may backtrack through the different pages to change values.

A configuration corresponds to the instantiation of a template, given the inputs of the user. User responses are sent from the host to the router using the http protocol.

After completing the answers to the questions of the configuration wizard (stepping through the wizard screens) the router saves all information gathered in the template file for further use and generates a compact configuration file for its own use (the—as such—well known .ini file). The flag indicating whether a configuration has been carried out is set, and the originally requested page is loaded. The .ini file contains all required configuration commands for the router. As compared to the .tpl file, all parameterization and ‘wizard’ commands are removed.

The above process is illustrated by the flowchart of FIG. 7.

According a variant embodiment, several configuration files, corresponding either to different templates or to different instantiations of a same template may be stored by the router. However, only one configuration file is active at a given moment. A pointer is set to the active configuration and used until changed by the user (the corresponding wizard screen is not illustrated).

There are three levels of configuration: the user configuration, the ISP configuration and the default configuration. If for any reason, a topic required by the router software is not available in the user configuration, the software looks for this topic first in the ISP configurations and lastly in the default configuration. Topics present in the configuration files that are not required by the software are simply ignored. For the sake of clarity, a topic is a set of configuration commands configuring specific service or protocol. A group represents a wizard screen containing all kinds of configuration items that are not necessarily in a single topic.

Appendix A: Example of a Template File (Extract)

[wizard.ini ]

def var=atm type=grp desc=“ATM VPI/VCI value” help=“Configure the VPI/VCI value. This value should be provided by your ISP” alias=“ATM parameters” def var=vpvc type=combo grp=atm desc=“Select the correct VPI/VCI value” alias=“VPI/VCI” req=yes default=“8*35” data=“0*35,0*36,0*37,0*38,0*39,0*40,8*35,8*36,8*37,8*38,8*39,8*40”

def var=ppp type=grp desc=“Configure PPP parameters” alias=“Point-to-point_protocol” help=“Configere the PPP, settings. These values should be provided by your ISP”

def var=ppptype type=list grp=ppp alias=“PPP type” desc=“Select the PPP type” data=“PPPoA,PPPoE”

def var=dialtype type=list grp=ppp alias=“Dial-in mode” desc=“Select your preferred dial-in mode” data=“dial,dod,on” dalias=“Dial-in,Dial_on_demand,Always_on” default=“on”

Explanations of some of the commands used in the above template are given in the following paragraphs.

The ‘def’ command is a command line interface (CLI) command providing a way to describe the structured content and appearance of the setup wizard. The ‘def’ command has a global set of arguments having a specific meaning dependent on the type of definition. There are two types of definitions: group definitions and variable definitions. Variables are associated to a group. A group corresponds to the information presented on a single page of the wizard.

Table 1 gives the parameters of a group definition:

TABLE 1

| | | |
|---|---|---|
| var | Required | Name of the group (a ‘topic’ in the wizard), used as |
| | | a reference if variables are added. A user-friendly |
| | | name of the group can be specified using the ‘alias’ |
| | | parameter |
| type | Required | ‘grp’ (fixed value for a group) |
| grp | Ignored | |
| desc | Required | A text to be displayed in the header of the wizard |
| | | page screen |
| help | Optional | An additional help text to be displayed above the |
| | | variable section panel of the wizard screen |
| alias | Optional | User-friendly name of the group, which is displayed |
| | | in the top part on the page. If this field is not |
| | | specified, the group name (var) will be used instead. |
| req | Ignored | |
| default | Ignored | |
| data | Ignored | |
| dalias | Ignored | |
| min | Ignored | |
| max | Ignored | |

Table 2 indicates a group variable definition

TABLE 2

| | | |
|---|---|---|
| var | Required | Name of the environment variable. |
| | | A user-friendly name of this variable can be set |
| | | using the alias parameter. |
| type | Required | Type of the variable, defining among other things |
| | | the presentation on a page by the wizard. |
| grp | Required | The name of the group to which this variable |
| | | belongs. |
| desc | Required | A text describing the variable or the action requested |
| | | from the user in association with this variable, for |
| | | display on the page |
| help | Ignored | |
| alias | Optional | User-friendly name of the variable, as it will be used |
| | | for display. If not specified, the name pas given by |
| | | var will be used. |
| Req | Optional | Specifies whether a value is required for this vari- |
| | | able or not. |
| default | Optional | Specifies a default value. If specified, this value is |
| | | displayed as the default value (e.g. in a list of |
| | | possible values) |
| data | Optional | Possible values for this variable. |
| dalias | Optional | User-friendly names for each possible value. |
| min | Optional | Type dependent parameter |
| max | Optional | Type dependent parameter |

Possible variable types are: String, Password, Integer, Combo List, List, Boolean, IP Address, IP Mask, Radio (set of exclusive choices).

1. A router or bridge device comprising
means for connection to a first network and means for connection to a second network;
an application for selecting configuration parameters, wherein the application applies a template for presenting parameters to a user, said template being uploadable to said device.

2. Device according to claim 1, comprising a plurality of templates.

3. Device according to claim 2, wherein the application comprises means for generating a template selection display to a user.

4. Device according to claim 2, wherein the application comprises means for loading a template from at least one of: a host device connected to the second network, a server connected to the first network.

5. Device according to claim 1, wherein said application is a web server provided with means for generating pages for display on a remote display.

6. Device according to claim 5, wherein said display is part of a host device comprising a browser for accessing the pages and for interacting with a user for selection of the configuration parameters.

7. Device according to claim 1, wherein the application is adapted to generate at least one configuration file based on at least one template.

8. Device according to claim 7, comprising a factory default configuration.

9. Device according to claim 7, comprising a configuration predetermined by an Internet service provider.

10. Device according to claim 9, wherein a priority is established between a user configuration, an internet service provider configuration and a factory default configuration in that order and wherein a parameter required by device software not found in one configuration is taken from a lower priority configuration.
